(19) United States
(12) Patent Application Publication
(10) Pub. No.: US 2008/0304569 A1
(43) Pub. Date: Dec. 11, 2008

(54) Method and apparatus for encoding and decoding image using object boundary based partition

(75) Inventors: Kyo-hyuk Lee, Yongin-si (KR); Jianle Chen, Suwon-si (KR); Woo-jin Han, Suwon-si (KR); Sang-rae Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/134,657

(22) Filed: Jun. 6, 2008

Related U.S. Application Data
(60) Provisional application No. 60/942,756, filed on Jun. 8, 2007.

(30) Foreign Application Priority Data
Oct. 11, 2007 (KR) 10-2007-0102583

(51) Int. Cl. H04N 7/32; H04N 7/26

(52) U.S. Cl. 375/240.16; 375/240.12; 375/E07.125

(57) ABSTRACT

Provided are a method and apparatus for encoding and decoding an image. The image encoding method includes searching for a reference block for obtaining partition information of a current block, referring to at least one reference picture; dividing the current block based on the partition information obtained from the reference block and performing inter prediction with regard to each of a plurality of partitions included in the current block; and encoding the current block based on a result of the inter prediction.

### CROSS-REFERENCE TO RELATED PATENT APPLICATION

This application claims the benefit of U.S. Provisional Application No. 60/942,756, filed on Jun. 8, 2007, in the U.S. Patent Trademark Office, and Korean Patent Application No. 10-2007-0102583, filed on Oct. 11, 2007, in the Korean Intellectual Property Office, the disclosures of which are incorporated herein in their entirety by reference.

### BACKGROUND OF THE INVENTION

1. Field of the Invention

Methods and apparatuses consistent with the present invention relate to encoding and decoding an image, and more particularly, to a method and apparatus for generating partitions in a variety of shapes for inter prediction of a macro block, performing the inter prediction, and encoding/decoding an image based on a result of the inter prediction.

2. Description of the Related Art

In conventional methods of compressing an image, such as MPEG-1, MPEG-2, and MPEG-4 H.264/MPEG-4 advanced video coding (AVC), a picture is divided into predetermined image processing units, e.g., macro blocks, in order to encode an image. Then, each macro block is encoded using inter prediction or intra prediction. Next, the macro blocks are encoded after selecting a suitable encoding mode by considering a data size of the encoded macro block and distortion of the original macro block.

In inter prediction, which is a representative example of motion estimation encoding, temporal redundancy between pictures is reduced and images are compressed. Motion estimation encoding estimates motion of a current picture per block using at least one reference picture, and predicts a current block based on a result of the motion estimation.

Motion estimation encoding for prediction of a current lock searches for a block that is most similar to the current block using a predetermined evaluation function within a designated search scope of a reference picture. When the most similar block is found, residue between the current block and the most similar block of the reference picture is transmitted in order to increase data compressibility. In motion estimation encoding, a variety of blocks such as 16×16, 8×16, 8×8 or the like can be used as a basic unit. This will be described in detail with reference to FIGS. 1 and 2.

FIGS. 1 and 2 illustrate conventional basic motion estimation blocks. Unlike MPEG-2, MPEG-4 H.264/MPEG-4 AVC may use various sizes of blocks as motion estimation blocks. Referring to FIG. 1, a variety of motion estimation modes such as 16×16 110, 16×8 120, 8×16 130, and 8×8 140 are used as basic blocks. When the motion estimation mode 8×8 140 is used as a basic block, motion of 8×8 blocks 142, 144, 146 and 148 is estimated using one of sub modes 210, 220, 230 and 240 shown in FIG. 2. That is, all seven sizes of blocks from 16×16 to 4×4 can be basic motion estimation modes.

In inter prediction encoding, the more exact the predication of a macro block is, the greater the reduction in residual data, which increases compressibility of image encoding. However, besides rectangular shapes, a variety of other shapes are included in images. In this case, if the macro block is conventionally divided into rectangular shapes and predicted, the macro block is not exactly predicted, resulting in a reduction in compressibility. Therefore, a method and apparatus for dividing the macro block into various types of partitions and effectively performing inter prediction are needed.

### SUMMARY OF THE INVENTION

The present invention provides a method and apparatus for dividing a current block into various types of partitions and more exactly performing inter prediction, and a computer readable recording medium having recorded thereon a program for executing the method.

According to an aspect of the present invention, there is provided an image encoding method comprising: searching for a reference block for obtaining partition information of a current block, referring to at least one reference picture; dividing the current block based on the partition information obtained from the reference block and performing inter prediction with regard to each of a plurality of partitions included in the current block; and encoding the current block based on a result of the inter prediction.

The encoding of the current block may comprise: subtracting a prediction block generated by the inter prediction from the current block and generating a residual block; and encoding the residual block.

The encoding of the current block may further comprise: searching for the reference block indicating encoding flag information or information on macro block modes for obtaining the partition information, dividing the current block based on the partition information obtained from the reference block, and performing the inter prediction with regard to each of the plurality of partitions included in the current block.

The performing of inter prediction may comprise: performing the inter prediction with regard to at least one of the plurality of partitions referring to the reference block.

According to another aspect of the present invention, there is provided an image encoding apparatus comprising: a partition generating unit searching for a reference block for obtaining partition information of a current block referring to at least one reference block and dividing the current block based on the partition information obtained from the reference block; a prediction unit performing inter prediction with regard to each of a plurality of partitions included in the current block; and an encoding unit encoding the current block based on a result of the inter prediction.

According to another aspect of the present invention, there is provided an image decoding method comprising: receiving image data and decoding the received image data; searching for a reference picture according to motion vectors with regard to a reference block generated by the decoding, obtaining partition information on a current block, and dividing the current block according to the partition information; performing inter prediction with regard to each of a plurality of partitions generated by the division using motion vectors with regard to the plurality of partitions generated by the decoding; and reconstructing the current block based on a result of the inter prediction.

According to another aspect of the present invention, there is provided an image decoding apparatus comprising: a decoding unit receiving image data and decoding the received image data; a partition generating unit searching for a reference picture according to motion vectors with regard to a reference block generated by the decoding, obtaining partition information on a current block, and dividing the current block according to the partition information; a prediction unit performing inter prediction with regard to each of a plurality of partitions generated by the division using motion vectors with regard to the plurality of partitions generated by the decoding; and a reconstruction unit reconstructing the current block based on a result of the inter prediction.

The partition information may include object boundary based partitions.

According to another aspect of the present invention, there is provided a computer readable recording medium having recorded thereon a program for executing the image encoding method.

### BRIEF DESCRIPTION OF THE DRAWINGS

The above and other features of the present invention will become more apparent by describing in detail exemplary embodiments thereof with reference to the attached drawings in which:

FIGS. 1 and 2 illustrate conventional basic motion estimation blocks;

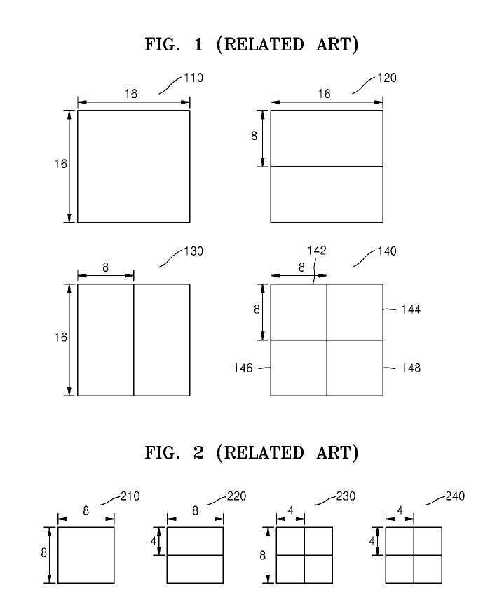

FIG. 3 is a block diagram of an image encoding apparatus according to an embodiment of the present invention;

FIG. 4A illustrates a reference block and a motion vector for the reference block for obtaining partition information according to an embodiment of the present invention;

FIG. 4B is a diagram for explaining an inter prediction method according to an embodiment of the present invention;

FIG. 4C is a diagram for explaining an inter prediction method according to another embodiment of the present invention;

FIG. 5 illustrates macro block modes according to an embodiment of the present invention;

FIG. 6 is a block diagram of an image encoding apparatus according to an embodiment of the present invention;

FIG. 7 is a flowchart illustrating an image encoding method according to an embodiment of the present invention;

FIG. 8 is a block diagram of an image decoding apparatus according to an embodiment of the present invention;

FIG. 9 is a block diagram of an image decoding apparatus according to another embodiment of the present invention; and

FIG. 10 is a flowchart illustrating an image decoding method according to an embodiment of the present invention.

### DETAILED DESCRIPTION OF THE INVENTION

Hereinafter, the present invention will be described more fully with reference to the accompanying drawings, in which exemplary embodiments of the invention are shown.

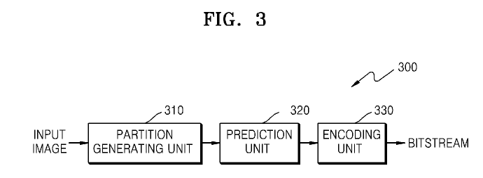

FIG. 3 is a block diagram of an image encoding apparatus according to an embodiment of the present invention. Referring to FIG. 3, the image encoding apparatus 300 includes a partition generating unit 310, a prediction unit 320, and an encoding unit 330.

The partition generating unit 310 searches for a reference block for obtaining partition information on a current block with reference to at least one reference picture, and divides the current block based on the partition information obtained from the reference block found by the search.

The partition generating unit 310 searches for a determined scope of a reference picture and discovers the reference block including the partition information on the current block. The partition generating unit 310 discovers the reference block including the optimum partition information suitable for encoding the current block according to rate-distortion (R-D) cost. Similar to the search for motion estimation, the partition generating unit 310 moves the reference block per pixel within the search scope, generates the partition information, divides the current block based on the generated partition information, and selects the reference block having the optimum R-D cost when encoding is performed.

The partition generating unit 310 may set partitions of the current block according to the boundary of objects included in the reference picture and a current picture. In more detail, partitions may be object boundary based partitions. Values of pixels included in a block have a different value on either side of the boundary of objects. Therefore, if values of pixels are divided into a plurality of groups according to a predetermined threshold value, pixels on either side of the boundary of objects are divided into different groups to generate object boundary based partitions.

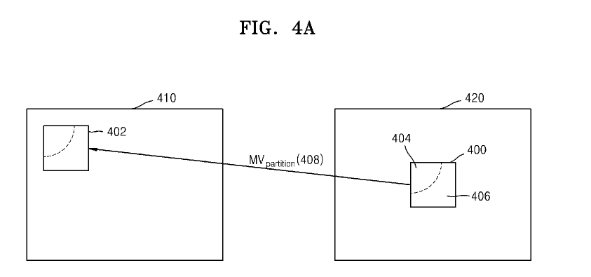

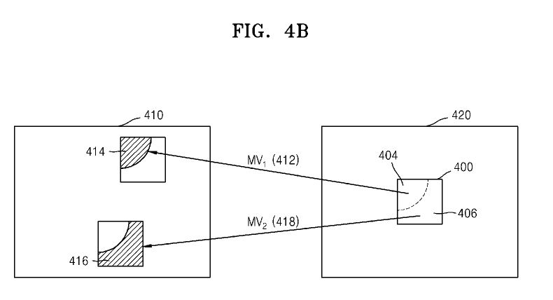

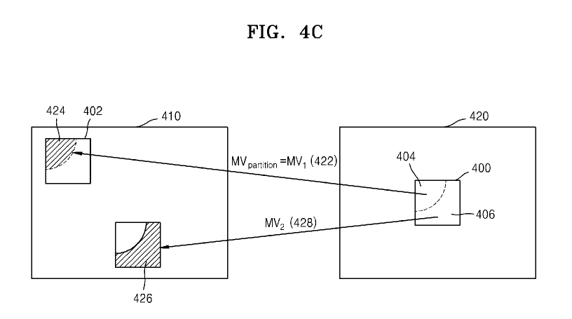

FIG. 4A illustrates a reference block 402 and a motion vector 408 for the reference block 402 for obtaining partition information according to an embodiment of the present invention. Referring to FIG. 4A, if a current block 400 is divided into various types of partitions 404 and 406 in order to prevent inaccurate conventional inter prediction, information on a division type of the current block when encoding is performed, i.e., partition information, needs to be separately encoded.

However, since the partition information generally has a large amount of data, although the current block 400 is divided into various types of blocks and is accurately predicted, compressibility of image encoding is reduced.

To address this problem, in the present embodiment, the partition information is not separately encoded but the reference block 402 is searched for in the reference picture 410 and the partition information on the current block 400 is obtained. It is highly possible that an image included in the reference picture 410 that is temporally adjacent to the current picture 420 is similar to an image of the current picture 420, so that it is highly possible that the reference block 402 having the similar partition information to the current block 400 is included in the reference picture 410. In the present embodiment, the similarity between adjacent pictures is used to justify the approximation that the partition information of the reference block 402 included in the reference picture 410 can be regarded as the same as the partition information on the current block 400. The current block 400 is divided according to the partition information to generate a plurality of partitions 404 and 406.

Referring back to FIG. 2, the prediction unit 320 performs inter prediction for the partitions 404 and 406 generated by the partition generating unit 310. The partitions 404 and 406 having an optional shape other than a rectangular shape are used to search for the reference picture 410, and the prediction unit 320 discovers most similar partitions to the partitions 404 and 406 in the reference picture 410, and predicts each partition based on a result of the search.

FIG. 4B is a diagram for explaining an inter prediction method according to an embodiment of the present invention. Referring to FIG. 4B, the prediction unit 320 performs motion estimation of the partitions 404 and 406 included in the current block 400 in order to perform the inter prediction. A partition 414 included in the reference picture 410 is a result of the motion estimation performed on the partition 404. A partition 416 included in the reference picture 410 is a result of the motion estimation performed on the partition 406.

In the present embodiment, the prediction unit 320 searches for the same picture as the reference picture 410 including the reference block 402 and performs the motion estimation of to the partitions 404 and 406 of the current block 400. However, the reference block 402 and the partitions 414 and 416 can be searched for in a different picture.

FIG. 4C is a diagram for explaining an inter prediction method according to another embodiment of the present invention. In the previous embodiment with reference to FIG. 4B, three motion vectors are needed to perform the motion estimation of the partitions 404 and 406. Three motion vectors are MVₚₐᵣₜᵢₜᵢₒₙ 408 for the reference block 402, MV₁ 422 for the partition 404, and MV₂ 428 for the partition 406.

In general, if the current block 400 is divided into n (n is a natural number greater than 2) partitions, since the motion vector 408 for specifying the reference block 402 is an additional vector needed in order to perform the motion estimation using the inter prediction method shown in FIG. 4B, n+1 motion vectors are needed.

Therefore, in order to reduce an additional increase of the motion vector 402, at least one of the partitions included in the current block 400 can be predicted from the reference block 402. Referring to FIG. 4C, the partition 404 is predicted from the partition 424 included in the reference block 402. In this case, since MVₚₐᵣₜᵢₜᵢₒₙ 408 for the reference block 402 is the same as MV₁ 422 for the partition 404, two motion vectors are needed to perform the inter prediction.

Referring back to FIG. 2, the encoding unit 330 encodes the current block 400 based on the inter prediction result of the prediction unit 320.

The encoding unit 330 performs the inter prediction of the partitions of the current block 400, generates a prediction block of the current block 400, subtracts the prediction block from the current block 400, and generates a residual block. The encoding unit 330 performs discrete cosine transform of the residual block, generates coefficients of a frequency region, entropy encodes the coefficients, and generates a bitstream.

The encoding unit 330 encodes motion vectors necessary for performing the inter prediction and inserts the motion vectors into the bitstream. When the inter prediction shown in FIGS. 4A and 4B is performed, the encoded motion vectors include the motion vector for the reference block 402 and the motion vectors 412 and 418 for each of the partitions. When the inter prediction shown in FIG. 4C is performed, the number of the encoded motion vectors is smaller than that shown in FIGS. 4A and 4B. The encoding unit 330 encodes the motion vector 422 for the reference block 402 and the motion vector 428 of the partition that does not refer to the reference block 402 for the inter prediction, and inserts the encoded motion vectors into the bitstream.

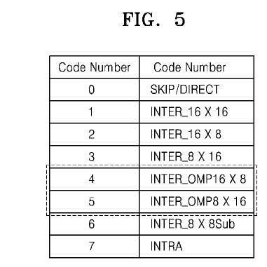

The encoding unit 330 encodes information indicating that the current block 400 is encoded using the inter prediction method shown in FIGS. 4A through 4C. The present invention provides new inter prediction modes different from the conventional inter prediction modes obtained by dividing a current block into rectangular shapes. This will be described in detail with reference to FIG. 5.

FIG. 5 illustrates macro block modes according to an embodiment of the present invention. Referring to FIG. 5, the macro block modes “SKIP/DIRECT”, “INTER_{—}16×16”, “INTER_{—}16×8”, “INTER_{—}8×16”, “INTER_{—}8×8Sub”, and “INTRA” are conventionally used in the MPEG-4 H.264/MPEG-4 AVC. In the present embodiment, new macro block modes “INTER_OMP16×8” and “INTER_OMP8×16” are added to the conventional macro block modes. A current block is divided into two partitions such as the macro block modes “INTER_{—}16×8” and “INTER_{—}8×16”, which are new macro block modes based on object boundary based partitions, to perform inter prediction. Motion vectors of the macro block mode “INTER_OMP16×8” are predicted using the same method as used in the macro block mode “INTER_{—}16×8”. Motion vectors of the macro block mode “INTER_OMP8×16” are predicted using the same method as used in the macro block mode “INTER_{—}8×16”.

In the present embodiment, the macro block modes “INTER_OMP16×8” and “INTER_OMP8×16” are examples of macro block modes that obtain partition information on a current block from a reference block, divide the current block into partitions, and perform the inter prediction of each partition.

The inter prediction method of the present invention can be distinguished from the conventional inter prediction method by using flag information only without newly establishing macro block modes. For example, flag information indicating that a current block is encoded using the inter prediction method shown in FIGS. 4A through 4C is added to a bitstream generated by encoding the current block so that the inter prediction method of the present invention can be easily identified from the conventional inter prediction method.

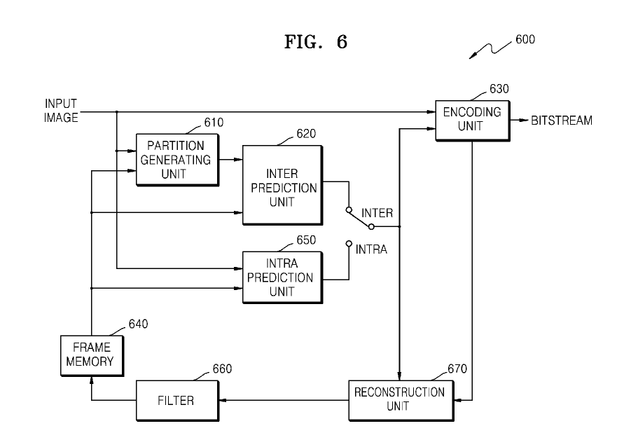

FIG. 6 is a block diagram of an image encoding apparatus 600 according to an embodiment of the present invention. Referring to FIG. 6, the image encoding apparatus 600 comprises a partition generating unit 610, an inter prediction unit 620, an encoding unit 630, a frame memory 640, an intra prediction unit 650, a filter 660, and a reconstruction unit 670. The image encoding apparatus 600 includes the image encoding apparatus 300 shown in FIG. 3. Comparing the image encoding apparatuses 300 and 600, the partition generating unit 310, the prediction unit 320, and the encoding unit 310 shown in FIG. 3 correspond to the partition generating unit 610, the inter prediction unit 620, and the encoding unit 630, respectively.

The partition generating unit 610 searches for the reference picture 410 stored in the frame memory 640, and searches for the reference block 402 in order to obtain the partition information on the current block 400. The partition generating unit 610 divides the current block 400 based on the partition information to generate a plurality of partitions that perform the inter prediction. It was described that the partitions are based on boundaries of objects included in an image.

The inter prediction unit 620 performs inter prediction of the plurality of partitions generated in the partition generating unit 610. The inter prediction unit 620 searches for previously encoded pictures that are stored in the frame memory 640 using each of the partitions generated in the partition generating unit 610, performs motion estimation of the partitions, and performs motion compensation based on motion vectors generated by the motion estimation, so that a prediction block of the current block is generated.

The intra prediction unit 650 performs intra prediction of the current block using pixels included in a previously encoded region adjacent to the current block.

The encoding unit 630 encodes the prediction block generated in the inter prediction unit 620 or the intra prediction unit 650. The encoding unit 630 subtracts the prediction block from the current block, generates a residual block, and performs discrete cosine transform of the residual block. Discrete cosine coefficients generated by the discrete cosine transform are entropy encoded and are inserted into a bitstream.

The encoding unit 630 encodes the motion vectors used for the inter prediction of the present invention and inserts the motion vectors into the bitstream. The motion vectors shown in FIGS. 4A through 4C are encoded and inserted into the bitstream. Information indicating that the current block is intra predicted using the inter prediction method of the present invention, for example, macro block modes or flag information, is encoded and is inserted into the bitstream.

The reconstruction unit 670 decodes the residual block encoded in the encoding unit 630, adds the decoded residual block to the prediction block, and reconstructs the current block. The filter 660 deblocking filters the reconstructed current block, and stores the deblocking filtered current block in the frame memory 640.

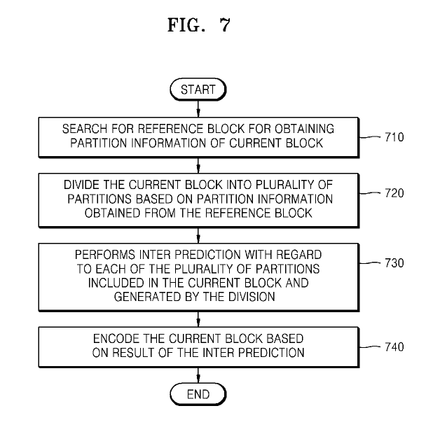

FIG. 7 is a flowchart illustrating an image encoding method according to an embodiment of the present invention. Referring to FIG. 7, the image encoding apparatus 300 or 600 searches for a reference block in order to obtain partition information of a current block referring to at least one reference picture (operation 710). The partition information used for inter prediction of the current block is searched for in a temporally adjacent reference picture and is obtained. It was described above that the partition information is information on an object boundary based partition.

The image encoding apparatus 300 or 600 divides the current block into a plurality of partitions based on the partition information obtained from the reference block found in operation 710 (operation 720).

The image encoding apparatus 300 or 600 performs inter prediction of each of the plurality of partitions generated in operation 720 (operation 730). The image encoding apparatus 300 or 600 performs motion estimation of each partition, calculates motion vectors, and performs motion compensation based on the calculated motion vectors. At least one of the plurality of partitions can be predicted by referring to the reference block found by obtaining the partition information.

The image encoding apparatus 300 or 600 encodes the current block based on the prediction block generated in operation 730 (operation 740). The image encoding apparatus 300 or 600 subtracts a prediction block from the current block, generates a residual block, and encodes the generated residual block. The image encoding apparatus 300 or 600 encodes the motion vectors used for the inter prediction and inserts the encoded motion vectors into a bitstream. Flag information or macro block modes indicating that the current block is encoded using an inter prediction method of the present invention or information on macro block modes is encoded and is inserted into the bitstream.

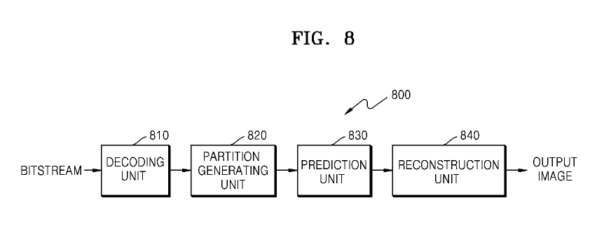

FIG. 8 is a block diagram of an image decoding apparatus 800 according to an embodiment of the present invention. Referring to FIG. 8, the image decoding apparatus 800 comprises a decoding unit 810, a partition generating unit 820, a prediction unit 830, and a reconstruction unit 840.

The decoding unit 810 receives image data, and decodes the received image data so that a residual block of a current block is generated and motion vectors used for inter prediction of the current block are generated. The motion vectors include motion vectors for a reference block necessary for obtaining partition information of the current block and motion vectors for inter prediction of each of the partitions included in the current block.

As a result of decoding the image data, it is determined whether flag information or macro block modes indicating that the current block is inter predicted using the inter prediction method shown in FIGS. 4A through 4C is included in the image data, and whether to perform decoding according to the present invention described below is determined.

The partition generating unit 820 obtains the partition information on the current block from a reference block using the motion vectors for the reference block. The partition generating unit 820 searches for a reference picture according to the motion vectors for the reference block, discovers the reference block, and uses partition information on the reference block as the partition information on the current block. The partition generating unit 820 divides the current block based on the partition information thus generating a plurality of partitions.

The prediction unit 830 performs inter prediction of each of the plurality of partitions. As described above, the motion vectors used for the inter prediction of each of the plurality of partitions included in the current block are generated. The prediction unit 830 performs the inter prediction of the plurality of partitions using the motion vectors to generate a prediction block. When at least one of the plurality of partitions is prediction encoded referring to the reference block, the inter prediction is performed using the motion vectors for the reference block.

The reconstruction unit 840 adds the prediction block generated by the inter prediction in the prediction unit 830 to the residual block generated by the decoding in the decoding unit 810 and reconstructs the current block.

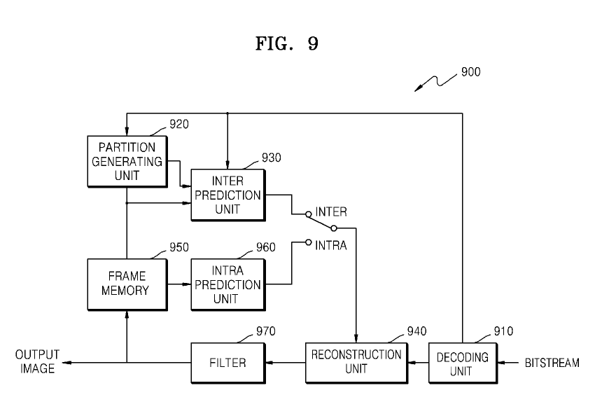

FIG. 9 is a block diagram of an image decoding apparatus 900 according to another embodiment of the present invention. Referring to FIG. 9, the image decoding apparatus 900 comprises a decoding unit 910, a partition generating unit 920, an inter prediction unit 930, a reconstruction unit 940, a frame memory 950, an intra prediction unit 960, and a filter 970. The image decoding apparatus 900 includes the image decoding apparatus 800 shown in FIG. 8. Comparing the image decoding apparatuses 800 and 900, the decoding unit 810, the partition generating unit 820, the prediction unit 830, and the reconstruction unit 840 shown in FIG. 8 correspond to the decoding unit 910, the partition generating unit 920, the inter prediction unit 930, and the reconstruction unit 940 shown in FIG. 9.

The decoding unit 910 receives image data and decodes the received image data, so that motion vectors necessary for inter prediction of a current block and a residual block are generated. The motion vectors include motion vectors for a reference block necessary for obtaining partition information on the current block and motion vectors of each of partitions included in the current block. It was described above that the partitions may be based on boundary of objects.

The partition generating unit 920 searches for a reference picture stored in the frame memory 950 according to the motion vectors for the reference block generated by the decoding in the decoding unit 910, obtains the partition information on the reference block, and divides the current block by using partition information of the reference block as the partition information on the current block.

The inter prediction unit 930 performs inter prediction of the plurality of partitions generated by dividing the current block in the partition generating unit 920. The inter prediction unit 930 searches for previously decoded pictures that are stored in the frame memory 950 using the motion vectors of the plurality of partitions, performs motion estimation based on a result of the search, and perform inter prediction of each of the plurality of partitions.

The intra prediction unit 960 performs intra prediction of the current block using pixels included in a previously encoded region that is adjacent to the current block. The reconstruction unit 940 adds a prediction block generated by the prediction in the inter prediction unit 930 and the intra prediction unit 960 to the residual block and reconstructs the current block. The filter 970 deblocking filters the reconstructed current block and stores the deblocking filtered current lock in the frame memory 950.

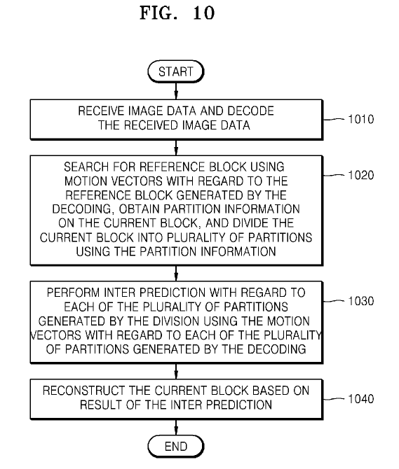

FIG. 10 is a flowchart illustrating an image decoding method according to an embodiment of the present invention. Referring to FIG. 10, the image decoding apparatus 800 or 900 receives image data and decodes the received image data (operation 1010). The image decoding apparatus 800 or 900 decodes the image data and generates residual data of a current block and motion vectors necessary for the inter prediction of the current block. The motion vectors include motion vectors for a reference block for obtaining partition information on the current block and motion vectors of each of partitions included in the current block.

The image decoding apparatus 800 or 900 searches for the reference block using the motion vectors for the reference block generated in operation 1010, and obtains partition information on the current block from the found reference block (operation 1020). The image decoding apparatus 800 or 900 divides the current block into a plurality of partitions using the partition information.

The image decoding apparatus 800 or 900 performs inter prediction of the plurality of partitions generated in operation 1020 (operation 1030). The image decoding apparatus 800 or 900 performs the inter prediction of the plurality of partitions using the motion vectors of each of the partitions generated in operation 1010.

The image decoding apparatus 800 or 900 adds a prediction block of the current block generated in operation 1030 to the residual block generated in operation 1010 and reconstructs the current block (operation 1040).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. In other embodiments, other examples of computer readable recording medium include carrier waves (such as data transmission through the Internet). The computer readable recording medium can also be distributed over network coupled computer systems so that the computer readable code is stored and executed in a distributed fashion.

According to the present invention, a current block is divided into various types of partitions other than rectangular shapes to perform inter prediction, thereby more exactly performing the prediction, and increasing compressibility of image data owing to encoding of the current block based on the exact prediction.

Further, although the current block is divided into various types of partitions, additional encoding of a partition map of the current block is not needed, thereby increasing compressibility of image data.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An image encoding method comprising:
searching for a reference block by referring to at least one reference picture;
obtaining partition information from the reference block;
dividing the current block based on the partition information and performing inter prediction of each of a plurality of partitions included in the current block; and
encoding the current block based on a result of the inter prediction.

2. The method of claim 1, wherein the partition information comprises object boundary based partitions.

3. The method of claim 1, wherein the encoding of the current block comprises:
subtracting a prediction block generated by the inter prediction from the current block and generating a residual block; and
encoding the residual block.

4. The method of claim 3, wherein the encoding of the current block further comprises:
encoding a motion vector for the reference block and motion vectors for performing the inter prediction of the plurality of partitions.

5. The method of claim 4, wherein the encoding of the current block further comprises:
searching for the reference block indicating encoding flag information or information on macro block modes for obtaining the partition information, dividing the current block based on the partition information obtained from the reference block, and performing the inter prediction of the plurality of partitions included in the current block.

6. The method of claim 1, wherein the performing of inter prediction comprises:
performing the inter prediction of at least one of the plurality of partitions by referring to the reference block.

7. An image encoding apparatus comprising:
a partition generating unit which searches for a reference block, obtains partition information of a current block from the reference block and divides the current block based on the partition information;
a prediction unit which performs inter prediction of a plurality of partitions included in the current block; and
an encoding unit which encodes the current block based on a result of the inter prediction.

8. The apparatus of claim 7, wherein the partition information comprises object boundary based partitions.

9. The apparatus of claims 7, wherein the encoding unit subtracts a prediction block generated by the inter prediction from the current block, generates a residual block, and encodes the residual block.

10. The apparatus of claim 9, wherein the encoding unit encodes a motion vector for the reference block and motion vectors for performing the inter prediction of the plurality of partitions.

11. The apparatus of claim 9, wherein the encoding unit searches for the reference block indicating encoding flag information or information on macro block modes for obtaining the partition information, divides the current block based on the partition information obtained from the reference block, and performs the inter prediction of the plurality of partitions included in the current block.

12. The apparatus of claim 7, wherein the prediction unit performs the inter prediction of at least one of the plurality of partitions by referring to the reference block.

13. An image decoding method comprising:
receiving image data and decoding the received image data;
searching for a reference picture according to a motion vector for a reference block generated by the decoding, obtaining partition information on a current block, and dividing the current block according to the partition information, in a division;
performing inter prediction of a plurality of partitions generated by the division using motion vectors of the plurality of partitions generated by the decoding; and
reconstructing the current block based on a result of the inter prediction.

14. The method of claim 13, wherein the partition information comprises object boundary based partitions.

15. The method of claim 13, wherein the performing of the inter prediction comprises:
performing the inter prediction of at least one of the plurality of partitions by referring to the reference block.

16. The method of claim 13, wherein the reconstructing of the current block comprises:
adding a residual block of the current block generated by the decoding of the image data to a prediction block generated by the inter prediction and reconstructing the current block.

17. An image decoding apparatus comprising:
a decoding unit which receives image data and decodes the received image data;
a partition generating unit which searches for a reference picture according to a motion vector for a reference block generated by the decoding, obtains partition information on a current block, and divides the current block according to the partition information, in a division;
a prediction unit which performs inter prediction of a plurality of partitions generated by the division using motion vectors of the plurality of partitions generated by the decoding; and
a reconstruction unit which reconstructs the current block based on a result of the inter prediction.

18. The apparatus of claim 17, wherein the partition information comprises object boundary based partitions.

19. The apparatus of claim 17, wherein the prediction unit performs the inter prediction of at least one of the plurality of partitions by referring to the reference block.

20. The apparatus of claim 17, wherein the reconstruction unit adds a residual block of the current block generated by the decoding of the image data to a prediction block generated by the inter prediction and reconstructs the current block.

21. A computer readable recording medium having recorded thereon a program for executing the method of claim 1.
